(19) United States
(12) Patent Application Publication
(10) Pub. No.: US 2005/0227154 A1
(43) Pub. Date: Oct. 13, 2005

(54) Image output controlling method and image output controlling program

(75) Inventor: Wataru Motoki, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Konica Minolta Medical & Graphic, Inc., Tokyo (JP)

(21) Appl. No.: 11/095,875

(22) Filed: Mar. 31, 2005

(30) Foreign Application Priority Data
Apr. 7, 2004 (JP) JP2004-112902

(51) Int. Cl. H05B 33/00

(52) U.S. Cl. 430/22

(57) ABSTRACT

By configuring, in terms of hardware or software, an image output control means which automatically sets the film size, the film orientation, and the direction of dividing the film by using the image size, the image diagnosing direction, and the number of image frames as the input parameters, it is not necessary to set the output conditions every time a medical image is to be outputted, and in particular, when there is no dedicated operator and the radiographing is done mostly under a fixed pattern, such as in a medical practitioner's clinic, it is possible to greatly enhance the ease of the operation.

This application is based on Japanese Patent Application No. 2004-112902 filed on Apr. 7, 2004 in Japanese Patent Office, the entire content of which is hereby incorporated by reference.

### BACKGROUND OF THE INVENTION

The present invention relates to an image output controlling method and an image output controlling program to control image output in a medical image diagnosis system whereby diagnosis is conducted by using a medical image acquired by radiographing a patient.

A radiographic image acquired by using radiation such as X-rays is widely employed as a medical image for disease diagnosis and, for example, so-called radiography has been used in such a way that X-rays transmitting through an examined body exposes a phosphor layer (fluorescent screen), and then visible light generated on the layer exposes film employing silver salt for development of the film, similar to an ordinary photograph.

However, recently, popular has been a radiographic image creating method by which a radiographic image is directly picked up as digital signals with a radiation detector such as stimulating phosphor or an FPD (Flat Panel Detector) without using a film coated with silver salt. Various kinds of image processing have been applied for the purpose of acquiring a radiographic image via the radiographic image creating methods to be more suitable for medical diagnoses.

Specifically, for example, a radiographic image transduction method which transduces visible light or infrared light into stimulation light, is disclosed in U.S. Pat. No. 3,859,527 and Tokkai Shyou 55-12144. This method uses a radiographic image transduction plate produced by forming a stimulable phosphor layer on a support. This is a method where a radiographic image transduction plate forming a stimulable phosphor layer on a support is employed so that accumulated radioactive energy is irradiated as a stimulating light by scanning a stimulable phosphor layer with stimulating light such as a laser beam of a prescribed wavelength. The stimulating light is then applied with photoelectric transformation by using a photoelectric transformation element such as a photomultiplier to pick out this stimulating light as an electric signal, after irradiating of radiation which has been transmitted through an examined body part, onto this stimulable phosphor layer so as to accumulate radiation energy corresponding to the radiation transmittance amount of each part of the examined body to form a latent image.

The radiographic image diagnosis system is known as computed radiography (CR) and is generally divided into two systems. One is a system dedicated for only patient's standing and lying positions in which a stimulable phosphor plate is installed in the reading apparatus, and the other is a cassette type system combining a portable cassette storing a stimulable phosphor plate inside and a reading apparatus (reader) which reads the data after removing the phosphor plate from the cassette. Regarding the cassette type system, the techniques are disclosed in Tokkai Nos. 2002-159476 and 2002-158820 for example.

This cassette type radiographic image diagnosis system will now be explained referring to FIG. 16. As shown in FIG. 16, conventional cassette type radiographic diagnosis system 1 is composed of a plurality of examination rooms in each of which radiographing apparatus 4 which radiographs examined body part M is installed and an operation space where image reading apparatuses (readers 2) are installed, each of which reads radiographic image data from portable cassette 17, in which a radiographic image transduction plate is housed incorporating stimulable phosphor sheet 18 which absorbs radiation energy. In each examination room, a controlling apparatus (controller 3) conducts display of a radiographic image, input of patient information and body part information as well as controlling reader 2. Further, reader 2, controller 3, job manager 19 and study manager 20 are connected as a LAN via switching hub 5.

In the examination room, a patient is positioned between radiation source 16 and cassette 17, and when a radiation is irradiated via radiation source 16, stimulable phosphor sheet 18 in cassette 17 then absorbs and stores a part of the radiation energy. After radiographing, this cassette is brought to the operation space and is set into reader 2, and reader 2 irradiates excitation light to expose stimulable phosphor sheet 18 in cassette 17 so that stimulable phosphor sheet 18 emits stimulable light corresponding to radiographic image information stored on it, and further photoelectric transduction is applied to the emitted stimulable light to output it as digital image data after A/D conversion.

Controller 3 has a display means for input of patient information or body part information and confirmation of the read image, as well as controls reading operation of reader 2. In this display means, for example, screens are displayed in the order, such as the reception list screen displaying a list of registered patients, the registration/search screen for registration of a new patient or for searching for patient information by inputting certain search data, the body part selection screen for setting the body part information for the selected patient, the image display screen displaying a radiographed image, or an image created by applying image processing to a radiographed image, the image processing adjustment screen to change image processing conditions to be used for image processing and the output property screen to output an image, so as to realize a work flow from reading to confirmation of images.

[Patent Document 1] Tokkai No. 2002-159476

[Patent Document 2] Tokkai No. 2002-158820

The medical image obtained by using the radiographing apparatus 4 is not only displayed on the screen of the controller 3, but also it is often outputted as a film (hard copy) using a printer such as a laser imager, etc. When the image displayed on the screen is outputted as a film, it is necessary to set various output conditions such as the size of the image (the size of cassette 17), the diagnosing direction of the image, the number of image frames recorded on one sheet of the film, etc.

However, although it is easy to set the different output conditions for outputting prints in a large hospital having an assigned operator specially for operating the controller 3, in a medical practitioner's clinic where only a few radiologists or doctors (almost one doctor) practice and since there is no special operator to operate controller 3, the radiologists or doctors themselves have to make the settings for printing out the images, which is inconvenient. Further, if the images are each printed on a single specific size film regardless of the size or the direction of the image, such as the commonly used 14″×17″ size which is the maximum size, cost becomes high because of inefficient use of film.

Further, in the case of a medical practitioner's clinic, it is rare that the radiographing operator (doctor) radiographs a number of body parts or in several directions as in a large hospital, and the radiographs are mostly taken of a specific size and pattern. Therefore, it is possible to automatically set the various conditions for printing out the images, and a proposal was being awaited for a system or method which made it possible to print out images by using simple operations.

The present invention was made in view of the above problems, and the main purpose of the present invention is to provide an image output controlling method and an image output controlling program in which it is possible to easily output medial images without having to set complex output conditions. In particular, according to the analyses made by the inventors et al., the maximum number of radiographs taken in a medical practitioner's clinic per patient is in most cases limited to 4, and the output method proposed here takes into consideration these actual conditions of usage.

The above objective can be achieved by the following method and program.

(A) An image output controlling method to output a radiographic image obtained by radiographing a subject on a film, comprising steps of: acquiring a size of the radiographic image, a diagnosing direction of the radiographic image and a number of frames of the radiographic images to be recorded on one sheet of the film, as input parameters, setting automatically a size of the film on which one or a plurality of the frames of the radiographic images are to be recorded, an orientation of the size of the film and a direction of dividing the size of the film when recording a plurality of frames of the radiographic images on the film based on the input parameters, according to a predetermined procedure.

(B) An image output controlling program to output a radiographic image obtained by radiographing a subject on a film, allowing a computer to function as an image output controlling means, comprising: an acquiring section to acquire a size of the radiographic image, a diagnosing direction of the radiographic image and a number of frames of the radiographic images to be recorded on one sheet of the film, as input parameters and a setting section to automatically set a size of the film on which one or a plurality of the frames of the radiographic images are to be recorded, an orientation of the size of the film, and a direction of dividing the size of the film when recording a plurality of frames of the radiographic images on the film based on the input parameters, according to a predetermined procedure.

In addition, the program according to the present invention is an image output controlling program in a medical imaging system functioning to output on a film the radiographic image obtained by radiographing the patient's body, and which makes the computer function as an image output control means that takes as input parameters the size of the radiographic image, the diagnosing direction of the radiographic image, and the number of frames of the radiographic images to be recorded on one sheet of film, and automatically sets according to a predetermined procedure the size of the film on which one or a plurality of the radiographic images are to be recorded, the orientation of the film, and the direction of dividing the film when recording a plurality of frames of the radiographic images on the film.

In this manner, according to the present invention, since the output is made after the size of the film, the orientation of the film and the direction of dividing the film are all automatically set according to the image output controlling program taking as input parameters the size of the image, the diagnosing direction of the image and the number of frames of the images, the user does not have to set the output conditions every time an image is to be outputted, and in particular, when there is no dedicated operator and the radiography is done mostly in a fixed pattern such as in a medical practitioner's clinic, it is possible to greatly ease operation of the system.

According to the image output controlling method and the image output controlling program of the present invention, when outputting a medical image in a printer such as a laser imager, the user does not have to set the output conditions every time an image is to be outputted, and in particular, when there is no dedicated operator and the most radiography is done in a fixed pattern, such as in a medical practitioner's clinic, it is possible to greatly ease operation of the system.

The reason for this is because the film size, film orientation, and the direction of dividing the film are set automatically according to predetermined rules taking as input parameters, the image size, the diagnosing direction of the image and the number of frames of the images.

### BRIEF DESCRIPTION OF THE DRAWINGS

FIG. 1 is a diagram showing a structure of a radiographic image diagnosis system including a controller related to an embodiment of this invention.

FIG. 2 is a block diagram showing a structure of a reader and a controller related to an embodiment of this invention.

FIG. 3 is a perspective view showing a structure of a cassette used in a radiographic image diagnosis system related to an embodiment of this invention.

FIG. 4 is a schematic diagram showing a procedure of processing (pre-registration mode) in a radiographic image diagnosis system related to an embodiment of this invention.

FIG. 5 is a schematic diagram showing a procedure of processing (post-registration mode) in a radiographic image diagnosis system related to an embodiment of this invention.

FIG. 6 is a diagram showing a structural example of a screen (image confirmation/output screen) displayed on the display section of a controller related to an embodiment of this invention.

FIG. 7 is a diagram showing a structural example of a screen (print preview screen) displayed on the display section of a controller related to an embodiment of this invention.

FIG. 8 is a diagram showing a structural example of a screen (output property screen) displayed on the display section of a controller related to an embodiment of this invention.

FIG. 9 is a diagram showing a structural example of a screen (output property screen) displayed on the display section of a controller related to an embodiment of this invention.

FIG. 10 is a flowchart showing a series of processing employing a controller related to an embodiment of this invention.

FIG. 11 is a flowchart showing image output processing (no division or four divisions) employing a controller related to an embodiment of this invention.

FIG. 12 is a flowchart showing image output processing (two divisions) employing a controller related to an embodiment of this invention.

FIG. 13 is a schematic diagram showing image output processing (no division) employing a controller related to an embodiment of this invention.

FIG. 14 is a schematic diagram showing image output processing (two divisions) employing a controller related to an embodiment of this invention.

FIG. 15 is a schematic diagram showing image output processing (four divisions) employing a controller related to an embodiment of this invention.

FIG. 16 is a schematic diagram showing a structure of a conventional radiographic image diagnosis system.

### DETAILED DESCRIPTION OF THE PREFERRED EMBODIMENT

Preferred embodiments to achieve the aforementioned objective of this invention will be explained.

(1) The image output controlling method described in (A), comprising in a step of setting the size of the film: a first step of obtaining a short side (a) and a long side (b) of a size of a single frame of the radiographic image or of an overall size of an arrangement of a plurality of frames of the radiographic images, a second step of selecting a smallest sized film loaded in a printer, a third step of obtaining a short side (a′) and a long side (b′) of the selected film, a fourth step of comparing the short side (a) with short side (a′) and the long side (b) with the long side (b′) and of checking whether or not relations of a′≧a and also b′≧b are both satisfied, and a fifth step of designating the selected film as a film for recording the single frame or the plurality of frames of radiographic images when the relations are satisfied, or else, if the relations are not satisfied, of selecting a next smallest sized film and of repeating the steps from the third step onward.

(2) The image output controlling method described in (A), wherein when there are two frames of radiographic images to be recorded, designation of the film is carried out, for both the two frames of the radiographic images, for both arrangements of the frames in a left to right direction and in a top to bottom direction while maintaining a diagnosing direction of the respective frames, and when sizes of the two designated films are different, not only a smaller film of the two films is designated as a film where the two radiographic images are to be recorded but also a direction of dividing the film is set according to the direction of the arrangements of the frames of the radiographic images, and when there are four radiographic images to be recorded, a film is designated for outputting all the four radiographic images by arranging them in two rows and two columns while maintaining a diagnosing direction of each of four frames of the radiographic images.

(3) The image output controlling method described in (A), wherein in a step of setting the orientation of the film, an aspect ratio of an area for recording one frame of the radiographic image on the designated film is compared with an aspect ratio of the radiographic image in a diagnosing direction of the film, and the orientation of the film is set using a difference between the aspect ratios.

(4) The image output controlling method described in (A), wherein when only one frame of the radiographic image is present, the orientation of the film is set by comparing an aspect ratio of the designated film with an aspect ratio of the frame of the radiographic image in the diagnosing direction, when two frames of the radiographic images are present, the orientation of the film is set by comparing an aspect ratio of 1/2 of an area of the film with an aspect ratio of one frame of the radiographic image to be recorded in the 1/2 of the area in the diagnosing direction when the designated film is placed vertically, and also comparing an aspect ratio of 1/2 of an area of the film with an aspect ratio of one frame of the radiographic image to be recorded in the 1/2 of the area in the diagnosing direction when the designated film is placed horizontally, and designating an orientation for which a sum of differences of the aspect ratio is smaller as the orientation of the film, and when four frames of the radiographic images are present, the orientation of the film is set by comparing an aspect ratio of 1/4 of an area of the film with an aspect ratio of one frame of the radiographic image to be recorded in the 1/4 of the area in the diagnosing direction when the designated film is placed vertically, and also comparing an aspect ratio of 1/4 of an area of the film with an aspect ratio of one frame of the radiographic image to be recorded in the 1/4 of the area in the diagnosing direction when the designated film is placed horizontally, and designating an orientation for which a sum of differences of the aspect ratio is smaller as the orientation of the film.

(5) The image output controlling program described in (B), comprising in a processing of setting the size of the film: a first processing of obtaining a short side (a) and a long side (b) of a size of a single frame of the radiographic image or of an overall size of an arrangement of a plurality of frames of the radiographic images, a second processing of selecting a smallest sized film loaded in a printer,
a third processing of obtaining a short side (a′) and a long side (b′) of the selected film, a fourth processing of comparing the short side (a) with short side (a′) and the long side (b) with the long side (b′) and of checking whether or not relations of a′≧a and also b′≧b are both satisfied, and a fifth processing of designating the selected film as a film for recording the single frame or the plurality of frames of radiographic images when the relations are satisfied, or else, if the relations are not satisfied, of selecting a next smallest sized film and of repeating the processing from the third processing onward.

(6) The image output controlling program described in (B), wherein the image output controlling program controls the image output controlling means so that, when there are two frames of radiographic images to be recorded, designation of the film is carried out, for both the two frames of the radiographic images, for both arrangements of the frames in a left to right direction and in a top to bottom direction while maintaining a diagnosing direction of the respective frames, and when sizes of the two designated films are different, not only a smaller film of the two films is designated as a film where the two radiographic images are to be recorded but also a direction of dividing the film is set according to the direction of the arrangements of the frames of the radiographic images and when there are four radiographic images to be recorded, a film is designated for outputting all the four radiographic images by arranging them in two rows and two columns while maintaining a diagnosing direction of each of four frames of the radiographic images.

(7) The image output controlling program described in (B), wherein the image output controlling program controls the image output controlling means so that, in a processing of setting the orientation of the film, an aspect ratio of an area for recording one frame of the radiographic image on the designated film is compared with an aspect ratio of the radiographic image in a diagnosing direction of the film, and the orientation of the film is set using a difference between the aspect ratios.

(8) The image output controlling program described in (B), wherein the image output controlling program controls the image output controlling means so that, when only one frame of the radiographic image is present, the orientation of the film is set by comparing an aspect ratio of the designated film with an aspect ratio of the frame of the radiographic image in the diagnosing direction, when two frames of the radiographic images are present, the orientation of the film is set by comparing an aspect ratio of 1/2 of an area of the film with an aspect ratio of one frame of the radiographic image to be recorded in the 1/2 of the area in the diagnosing direction when the designated film is placed vertically, and also comparing an aspect ratio of 1/2 of an area of the film with an aspect ratio of one frame of the radiographic image to be recorded in the 1/2 of the area in the diagnosing direction when the designated film is placed horizontally, and designating an orientation for which a sum of differences of the aspect ratio is smaller as the orientation of the film, and when four frames of the radiographic images are present, the orientation of the film is set by comparing an aspect ratio of 1/4 of an area of the film with an aspect ratio of one frame of the radiographic image to be recorded in the 1/4 of the area in the diagnosing direction when the designated film is placed vertically, and also comparing an aspect ratio of 1/4 of an area of the film with an aspect ratio of one frame of the radiographic image to be recorded in the 1/4 of the area in the diagnosing direction when the designated film is placed horizontally, and designating an orientation for which a sum of differences of the aspect ratio is smaller as the orientation of the film.

In order to achieve the aforementioned objective, another preferred embodiment will be explained.

As shown in a conventional technology, a conventional radiographic image diagnosis system is structured by targeting large hospitals where a plurality of radiographing apparatuses 4, readers 2 and controllers 3 are installed and a plurality of radiologists operate the radiographing apparatuses and a plurality of doctors diagnose by using radiographic images acquired by radiographing apparatus 4. Therefore, it is structured that an operator sets output conditions such as a film size, a film orientation and a film dividing direction on the output property screen to be able to output medical images of various body parts of various patients on films. However, in a small medical practitioner's clinic where there are few radiographing apparatuses 4, readers 2, controllers 3, radiologists and doctors, and limited patient's body parts are accustomed to be radiographed in a predetermined manner, it is desired to establish a system to be able to conduct diagnosis by using a radiographic images as easily and quickly as possible.

This invention enables to automatically set the output conditions such as a film size, a film orientation and a film dividing direction by structuring an image output controlling means in the controller as a hardware or a software, thereby ease of use for especially a small scale user such as a medical practitioner is improved by simplifying complicated operations during print outputting.

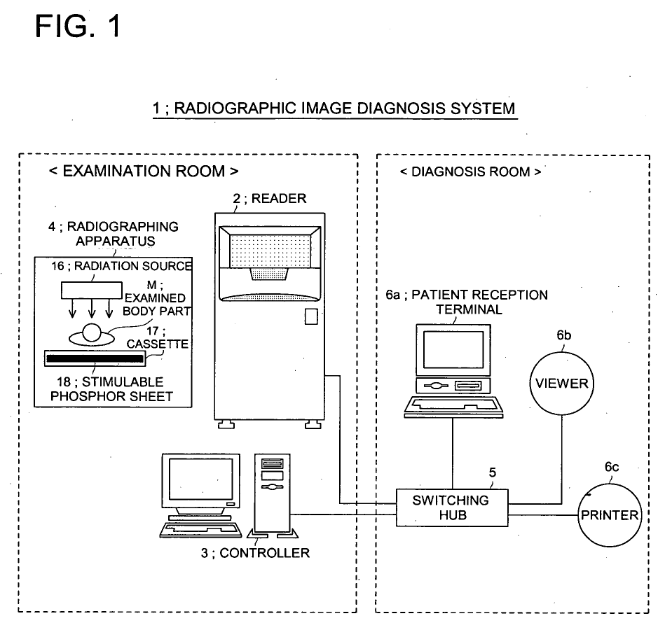

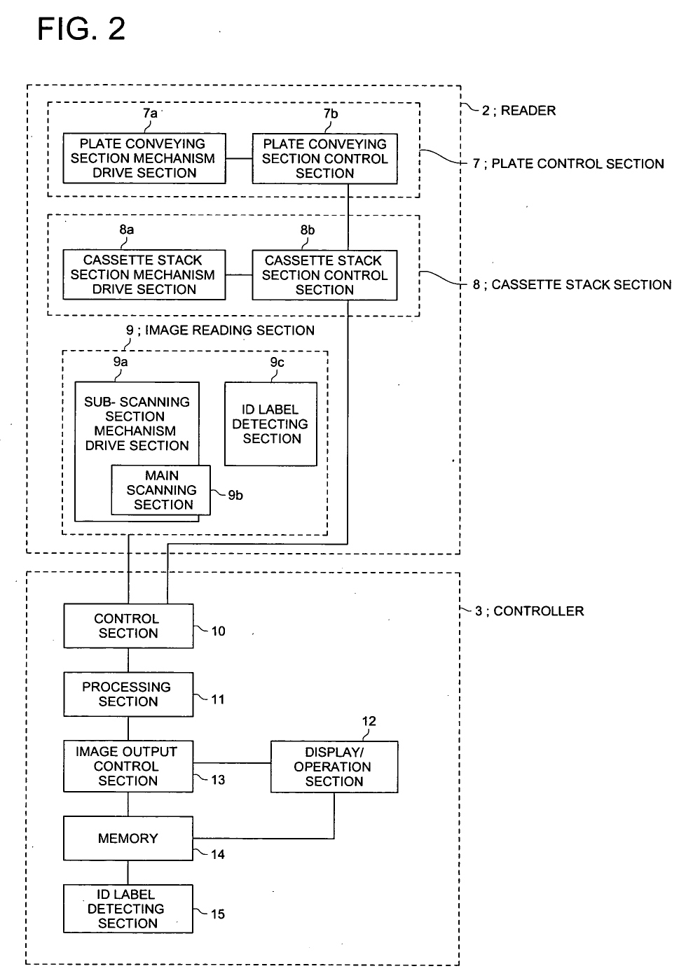

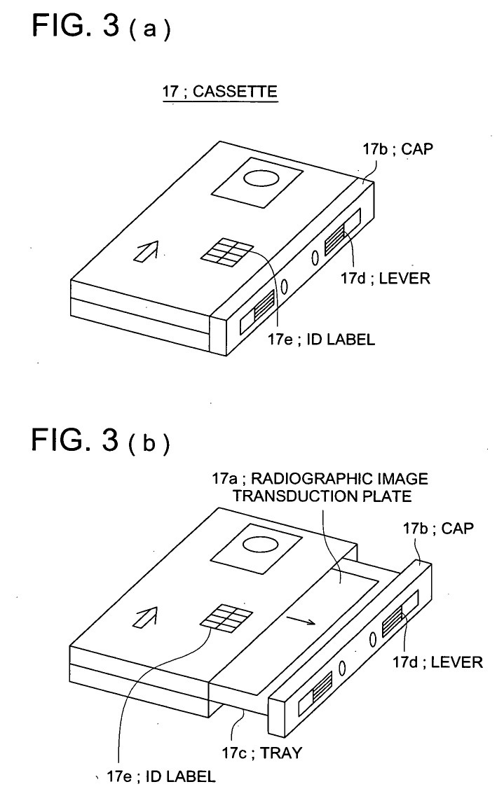

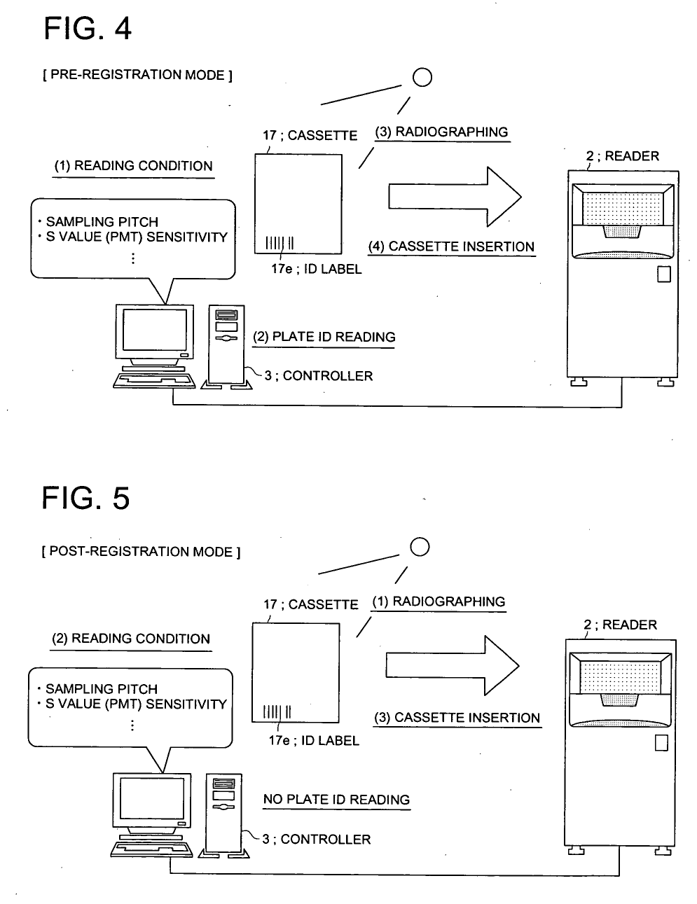

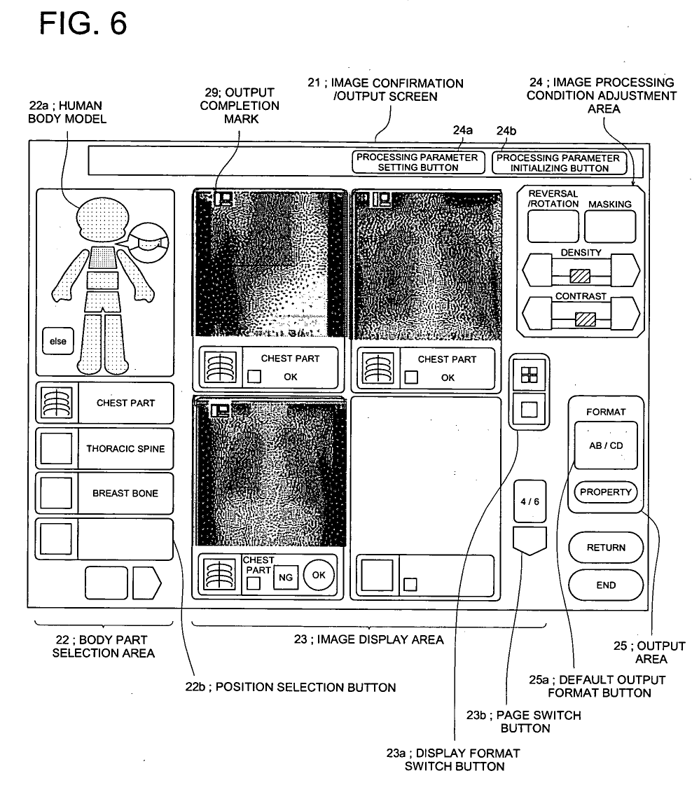

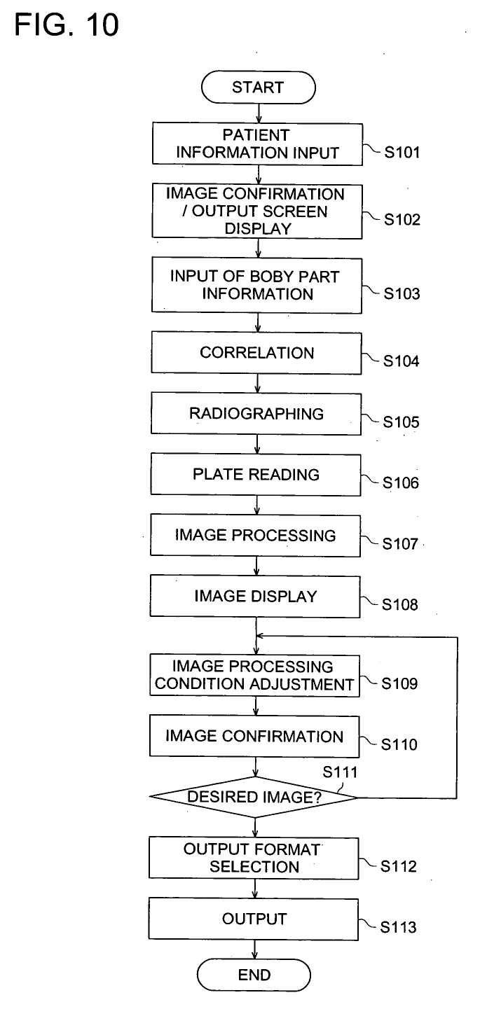

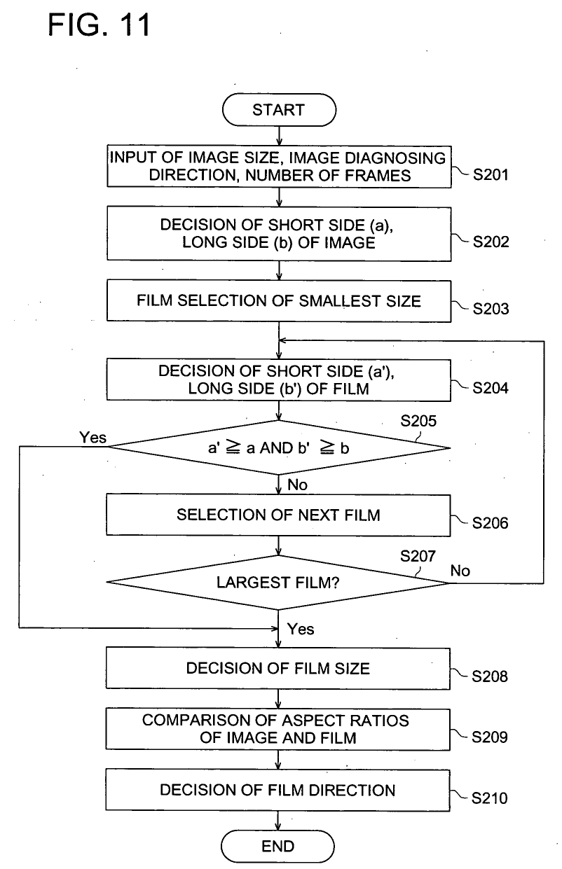

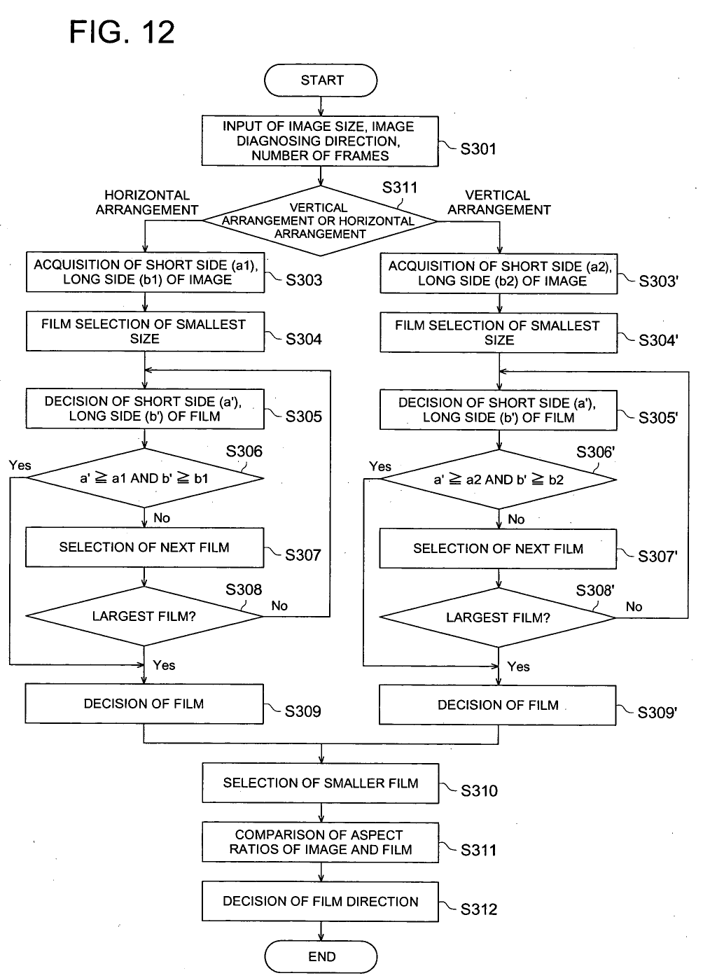

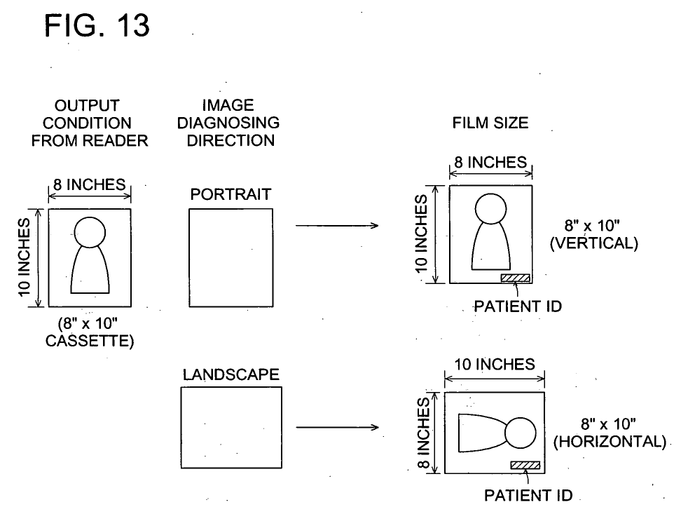

A medical image output controlling method and a image output controlling program related to an embodiment of this invention will be explained referring to FIGS. 1 through 15 to explain the embodiment of the afore-said invention in detail. FIG. 1 is a schematic diagram showing a structure of a radiographic image diagnosis system including a controlling apparatus (controller) of this invention. FIG. 2 is a block diagram showing a structure of an image reading apparatus (reader) and the controller. FIGS. 3(a) and 3(b) are perspective views showing the structure of a cassette. FIGS. 4 and 5 are diagrams explaining a registration system of radiographing conditions for image reading and FIGS. 6 through 9 are structural examples of images displayed by the controller. FIG. 10 is a flowchart showing a processing procedure employing the controller of this embodiment. FIGS. 11 and 12 are flowcharts showing output procedure and FIGS. 13 to 15 are schematic diagrams showing output procedure of a medical image.

In the following explanation, examples of applying this invention to radiographic image diagnosis system 1 of a cassette type, the invention is not limited to this embodiment and it can be applied to any apparatus displaying medical images in systems such as a system which uses other radiographic image transduction media and a system which directly takes out a radiographic image as digital signals by using a radiation detector such as an FPD. In this embodiment, reader 2 and controller 3 are arranged as separate means, however the controlling apparatus may be composed of their integration.

As shown in FIG. 1, in radiographic image diagnosis system 1, placed are reader 2 which reads out the radiographic image from cassette 17 where a latent image is formed by radiographing apparatus 4 and controlling apparatus (controller 3) which displays the read image and/or inputs patient information and body part information as well as controls the reading operation of reader 2 in a examination room where radiographing apparatus 4 which radiographs a patient is located. Reader 2 and controller 3 are connected to printer 6c, viewer 6b and patient reception terminal 6a which are installed according to the necessity via switching hub 5 as a LAN connection. Further, though it is not illustrated, these apparatuses are connected to other medical apparatuses by a network such as DICOM (Digital Image and Communications in Medicine). FIG. 1 is an example of radiographic image diagnosis system 1 and the number and/or the positioning of readers 2, controllers 3 and radiographing apparatuses 4 is not specifically limited.

Further, as shown in FIG. 2, reader 2 which reads image data acquired by radiographing apparatus 4 and controller 3 which controls the reading operation of reader 2, inputs patient information and/or body part information and displays a radiographic image based on image data, are directly connected or through a network. For example, as shown in FIG. 2, reader 2 is composed of cassette stack section 8 which controls the insertion of cassette 17, plate controlling section 7 which controls the conveyance of a radiographic image transduction plate including stimulable phosphor sheet 18 drawn from cassette 17 (refer to FIG. 3 regarding a structure of cassette 17), and image reading section 9 which reads the latent image while scanning of the radiographic image transduction plate.

In cassette stack section 8, cassette stack section mechanism drive section 8a and cassette stack section control section 8b are installed, and cassette 17 of a plurality of sizes can be set there. In plate control section 7, plate conveying section mechanism drive section 7a and plate conveying section control section 7b are installed, and plate conveying section control section 7b is controlled based on instructions from cassette stack section control section 8b. Plate conveying section mechanism drive section 7a draws a radiographic image transduction plate from cassette 17 and conveys it toward image reading section 9. In image reading section 9, sub-scanning section mechanism drive section 9a, main scanning section 9b and ID label detecting section 9c are installed and main scanning section 9b is conveyed in the sub-scanning direction by sub-scanning section mechanism drive section 9a. Information of ID label (plate ID) attached to cassette 17 is read by ID label detecting section 9c while image reading is being conducted by laser scanning of main scanning section 9b.

Controller 3, which conducts the reading control of reader 2, inputs patient information and body part information and displays a radiographic image based on image data, is equipped with control section 10 which controls reader 2, based on predetermined reading conditions. Processing section 11 which applies various image processing to an image read by reader 2 (such as contrast transformation processing, frequency processing, trimming, conversion/rotation and masking), display/operation section 12, image output control section 13 which automatically sets each output condition to output images to a printer such as a laser imager, memory 14 which stores image data for display, radiographing condition parameters of each body part, image processing parameters for image processing for each specific body part optimally and each output format and ID label detecting section 15 reading plate ID of cassette 17. Each means above can be structured in controller 3 as hardware and can also be structured as a display controlling program so that a computer can be structured to be, at least, image output control section 13 and the display controlling program is installed in controller 3 to perform.

In image output control section 13, as will be described later, with the image size (the size of cassette 17), the image reading direction and the number of image frames recorded on one film being input parameters, the size of the film to be outputted, the direction of the film, the dividing direction of the film are automatically set and the image output is controlled.

Radiographing condition parameters stored in above memory 14 are parameter set corresponding to each body part to be radiographed and reading conditions in the image reading stage of reader 2 (such as sampling pitch and sensitivity of reading) and the ID number of image processing parameters to be referred to, are stored after being sorted by each body part to be radiographed.

These image processing parameters are parameters which applies for optimal image processing to a certain body part and stores parameter values of each image processing such as a look-up-table defining the gradation curve of contrast transformation processing and the accentuation level of frequency processing sorted for each specific body part. The output format is a format which defines how many images of image data is stored and in which direction each image of image data is oriented on a single film when an image is outputted to printer 6c such as a laser imager and one or plural images of image data is incorporated into an output format which the operator selected on display, operating section 1 and each image of image data and additional information such as format information are outputted to DICOM printer 6c.

In the above-stated radiological image diagnosis system 1 of cassette type, to clarify the correlation between body part information and cassette 17, either a method in which radiographing is conducted after correlation of body part and cassette 17 is registered as radiographing reservation information (pre-registration) or a method in which body part information and the cassette insertion order is registered as radiographing reservation information without the registration of cassette 17 before radiographing (post-registration) is employed and then reading of image data is carried out.

Regarding input of body part information, a normal mode and a repeat mode are provided and one of them is selected. The normal mode is a mode in which whenever body part information is inputted on display/operation section 12 of controller 3, radiographing of the body part is reserved. On the other hand, the repeat mode is a mode in which selected body part information is preserved as a setting value of body part information for the reading operation, and after this, input of body part information can be omitted in the case of the repetition of image reading of the same body part.

Operations of the pre-registration mode and the post-registration mode of the normal mode will be explained via FIGS. 4 and 5.

In the case of the pre-registration mode, as shown in FIG. 4, an operator such as radiologist inputs body part information on display/operation section 12 ((1) in FIG. 4). At this time, information of ID label 17e (refer to FIGS. 3(a) and 3(b)) which has been attached on cassette 17, is read by ID label detecting section 15 of controller 3 ((2) in FIG. 4). Then, inputted body part information and plate ID are correlated and stored. After this, radiographing is performed by using the registered cassette 17 ((3) in FIG. 4), and cassette 17 where latent image has been formed, is inserted into reader 2 ((4) in FIG. 4). In reader 2, plate ID of cassette 17 is read by built-in ID label detecting section 9c and body part information corresponding to this plate ID is searched for and acquired. Further, a parameter set of radiographing conditions corresponding to the body part information, and reading conditions for reading an image by reader 2 is acquired from the parameter set. Then, reading of an image is conducted according to the acquired reading conditions. The read image data are sent to the controller, and in the controller, the ID number of the image processing parameters is acquired from a radiographing condition parameter set and image processing is applied to the read image according to the image processing conditions based on the image processing parameters.

In the case of-the post-registration mode, as shown in FIG. 5, an operator such as a radiologist first performs X-ray radiographing ((1) in FIG. 5) and after this, body part information is inputted on display/operation section 12 of controller 3 ((2) in FIG. 5). Here, in the case of the post-registration mode, correlation between the plate ID and body part information is not carried out so that reading of plate ID is not needed. Instead, the operator correlates the inputted body part information and the insertion order of cassette 17 into reader 2 and correlates and stores inputted body part information and the insertion order. When cassette 17, on which a latent image has been formed is inserted into reader 2 ((3) in FIG. 5), reader 2 searches for and acquires body part information corresponding to the insertion order and further reads out the radiographing condition parameter set corresponding to the body part information, and then acquires reading conditions from the parameter set to perform a reading operation of an image according to the reading conditions. After this, the same as in the pre-registration mode, the read image data are sent to the controller 3, which acquires the ID number of the image processing parameters from the radiographing condition parameter set to perform image processing to the read image according to the image processing conditions based on the image processing parameters.

Next, the repeat mode of the pre-registration mode and the post-registration mode will be explained.

In the case of the pre-registration mode, first an operator selects body part information on display/operation section 12 of controller 3. Whenever plate ID is read, the selected body part information and the plate ID are correlated and stored as radiographing reservation information. The operation hereafter is the same as in the normal mode of the pre-registration mode.

In the case of the post-registration mode, first the operator selects body part information on display/operation section 12 of controller 3. Whenever cassette 17 is inserted into reader 2, radiographing condition parameters of the selected body part are read out, and the image is read by acquiring reading conditions from the parameter set. After this, as the same as above, the read data are sent to the controller, and in which, the ID number of the image processing parameters is acquired from the radiographing condition parameters to apply image processing to the read image according to image processing conditions based on the image processing parameter.

Each of the pre-registration mode and the post-registration mode has each feature, for example, in a hospital where many readers 2 and controllers 3 are installed in various places and a plurality of radiologist perform radiographing, radiographic image diagnosis to a plurality of patients can be conducted accurately by the pre-registration mode and on the other hand, in a smaller medical practitioner's clinic where (almost) one reader 2 and one controller 3 are installed and one doctor who works as the above-mentioned radiologist performs radiographing, the radiographing is conducted quickly and effectively by the post-registration mode. The image processing method characterized by this embodiment is applicable to any registration modes. Further, setting of the normal mode and the repeat mode, and setting of the pre-registration mode and the post-registration mode can be chosen on a screen (not illustrated) and unless the setting is changed, the previous setting is maintained.

Next, a procedure to output a radiographic image of a patient, by means of radiographic image diagnosis system 1 of the abovementioned structure, on a printer such as a laser imager or a host terminal for the patient reception after radiographing will be explained referring to examples of screen structures in FIGS. 6 through 9, the flowcharts in FIGS. 10 to 12 and schematic diagrams in FIGS. 13 to 15. The procedure in the case of image reading in the pre-registration mode of the normal mode will be explained below, however the operation of the post-registration mode or the repeat mode after reading of image data is identical. A case in which a screen (image confirmation/output screen 21) optimal especially for a small scale user such as a medical practitioner's clinic is described below, however the structure of the screen is arbitrary, and even in a structure in which the reception list screen, the registration/search screen, the body part selection screen, the image display screen, the image processing adjustment screen and the output property screen are displayed in the order, the image output controlling method of this invention can be applied as the same.

First, in display/operation section 12 of controller 3, the patient information input screen (not illustrated) is displayed as an initial screen and information of the patient to be examined is inputted in Step S101. Then, in Step S102, image confirmation/output screen 21 including body part selection area 22, image display area 23 and image processing condition adjustment area 24, shown in FIG. 6, is displayed in display/operation section 12 of controller 3. Here, when patient information is received from a patient database or an examination database connected to a network, image confirmation/output screen 21 can be the initial screen without first displaying the patient information input screen and this initial screen is set on the setting screen (not illustrated).

Next, in Step S103, body part information is inputted by an operator, however for a small scale user such as a medical practitioner's clinic, if the body part selection screen, the image display screen and the image processing screen are changed complicatedly, the operation also becomes complicated. Therefore, it is structured that body part information is inputted by means of image confirmation/output screen 21 shown in FIG. 6. On this image confirmation/output screen 21, because body part or radiographing direction is limited for a small scale user such as a medical practitioner, there are provided on body part selection area 22, the first selection area including a schematic diagram of a human body (human body model 22a) so that any predetermined area (for example, the head, cervical part, chest, abdomen, pelvis, extremities and other body part) is selectable, and the second selection area including body part selection button 22b where body parts included in the selected area of human body model 22a (for example, in the case of the head area: head survey, cheek bone, jaw, nasal bone, acoustic organ and jaw; in the case of the cervical area: cervical vertebra, pharynx and larynx; in the case of chest area: chest, thoracic spine and breast bone; in the case of the abdomen area: abdomen, thoracic lumbar vertebrae, lumbar vertebrae and ribs; in the case of pelvis area: pelvis and hip joint; in the case of the extremities: Achilles tendon, axial heel, sesamoid bone; in the case of other body views: abdomen KUB/DIP, DIC/bladder contrast, neonatal chest abdomen, neonatal bones, cephalo, pantomography, parotid gland, submandibular gland, entire spine, long lower extremities) are displayed and are selectable, so that the desired body part is easily selected.

More specifically, when the operator selects a specific portion of human body model 22a (the chest for example), detailed body parts related to the selected portion (chest, thoracic spine or breast bone for example) are displayed on body part selection button 22b as a list of selectable body parts. The operator inputs body part information by selecting a specific body part from among them.

Next, the operator reads ID label 17e attached to cassette 17 by using ID label detecting section 15 of controller 3 in Step S104 and stores ID label information (plate ID) and body part information, which are correlated to each other.

Next, in Step S105, by means of a commonly known method, a patient is radiographed by using radiographing apparatus 4, such as X-ray radiographic apparatus, and an X-ray transmission image of the patient is recorded on the radiographic image transduction plate, in cassette 17 as a latent image. Here, radiographing apparatus 4 is not limited to only radiographing apparatus, but may also include apparatus which photographs patient by magnetism or a ultra-sound waves or any imaging apparatus used in the medical field.

Next, an operator such as a radiologist removes cassette 17 from radiographing apparatus 4 and inserts cassette 17 into any one of slots of reader 2. In the case of pre-registration mode, reader 2 reads the plate ID by ID label detecting section 9c and searches the database for stored radiographing reservation information while using the plate ID as a searching key to pick up body part information corresponding to the plate ID. In the case of post-registration, body part information corresponding to the insertion order is picked up by correlating the cassette insertion order queue with the body part reservation queue. After this, in Step S106, reader 2 reads out radiographing condition parameters correlated with the body part information and picks up the reading conditions out of them and reads the latent image on the radiographic image transduction plate according to the reading conditions.

As a reading procedure, first, according to the value of reading sensitivity, the sensitivity of image reading section 9 is set, and according to the value of reading resolution, the conveyance speed of plate conveying section mechanism drive section 7a and the sampling pitch of A/D converter installed in image reading section 9, are also set. Radiographic image transduction plate is removed from cassette 17, and image data stored and preserved on the radiographic image transduction plate are read out while the radiographic image transduction plate is sub-scanned in the X direction by sub-scanning mechanism drive section 9a.

When excitation light exposes the radiographic image transduction plate, energy stored in the phosphor is generated and this stimulation light is condensed to be converted into electric signals by image reading section 9, and further these electric signals are applied with logarithmic transformation by a logarithmic converter (Thereby, the electric signals are converted from electric signals having a proportional relationship with light intensity into electric signals having a relationship of logarithmic linear with the intensity of the stimulation light, that is electric signals having a linear relationship with the density), and further it is digitized by A/D converter.

The digitized image data outputted from the aforementioned image reading section 9 are displayed on image display screen 23 of image confirmation/output screen 21 at any time during the reading step.

After this, radiographing condition parameters corresponding to body part information is read out and image processing parameter ID number stored in it is acquired. Next, the image processing parameter set specified by the ID number is read out and image processing conditions are determined based on the image processing parameters. At this time, the ID number of the image processing parameter corresponding to each image is stored in the memory for every image. According to the determined image processing conditions, read image data are applied for image processing such as contrast transformation processing and frequency processing (Step S107). After completion of the image processing, the image data before image processing which were displayed on image display screen 23 of image confirmation/output screen 21 in the aforementioned reading step, are replaced by image data after image processing (Step S108).

Here, if the image read from the plate is displayed on a screen different from the screen for selecting body parts, it is difficult to compare the selected body part with the image, and the operation is complicated because the body part selection screen and the image display screen need to be changed each time. Therefore, by providing image display area 23 displaying the image, in addition to body part selection area 22 in image confirmation/output screen 21, the comparison between the body part and the image is simplified.

Because a schematic diagram and letters composing body part selection button 22b are displayed near each image in image display area 23, it is easy to compare each of the images with the body part, by inputting body part information with human body model 22a, and body part selection button 22b after selection of body part information displayed near this image, reading of radiographing condition parameters is carried out similarly to image processing during the reading stage and image processing can be conducted again based on inputted body part information.

In image display area 23, the single image display where only one image is displayed widely, or the four image display where the display area for one image is divided into four to align four images for display, can be selected with display format switch button 23a. While a plurality of read images of image data is stored in memory 14, images displayed in image display area 23 can be changed with page switch button 23b, and when page switch button 23b is pushed, in the case of the single image display, the image is changed into another one which is also stored next to the previous image in memory 14, and in the case of the four image display, the four images are changed into other four images which are also stored next to the previous images in memory 14. Further, by an input operation, each image can be switched into one of the conditions of select/non-select, and for the image set at the select condition, a framed box surrounding the image is displayed in the image display area and the condition of whether selection or non-selection is recorded for each image. The condition of selection/non-selection can be switched by selecting each image area displayed in image display area 23, or by providing a plural image selection condition switching button on the screen, and at every time when the button is pushed, switching and recording of the single image selected condition or the plural image selected condition can be conducted. In the case of the plural image selected condition, the condition of selection/non-selection can be switched by selecting either image area displayed in image display area 23 as described before, and in the case of the single image selected condition, only the selected image can become the selected condition by selecting each image area displayed in image display area 23.

Next, in step S109, when the image displayed on image display areas 23 is not the desired image for the operator, slight adjustments of image processing conditions on image processing condition adjustment area 24 can be performed. Here, the operation is complicated by the structure in which the conditions of image processing is adjusted on this image processing condition adjustment screen, by selecting the screen for the image processing condition adjustment when the image processing condition for the displayed image is adjusted. Further, it is also inconvenient because the image processing condition can not be adjusted while surveying a plurality of screens. Therefore, density or contrast of the image can be adjusted by a button or a slide bar without changing the screens by providing image processing condition adjustment area 23 on image confirmation/output screen 21. Here, tone processing is picked up and an example of the parameter change of density (maximum density) and contrast (γ curve) is shown as an example of adjustable image processing, however instead of these or together with them, adjustment of parameter related to other processing such as accentuation level in frequency processing may also be adjustable. Further, in FIG. 11, although image processing condition adjustment area 24 is provided in the upper right of image confirmation/output screen 21, the structure or the position of image processing condition adjustment area 24 is optional, and a layout change of each area such as a change of the position of image processing condition adjustment area 24 and body part selection area 22 can be carried out according to the use conditions after the image is displayed on image display area 23.

As mentioned above, because image data, which are image-processed according to the image process conditions after adjustment, are immediately displayed on image display area 23, the operator can obtain the desired image by repeating the adjustment operation on image processing condition adjustment area 24 while confirming the image (Steps S110 and S111).

It is possible that the simultaneous adjustment of these image processing conditions can be carried out to a plurality of images. In this case, a plurality of images are set in a selected condition and the same variation amount is added to all the image processing conditions of all the images set in the selected condition by an adjusting operation on the image processing condition adjustment section and images which are image-processed by the new image processing conditions are subsequently displayed on image display area 23. In the condition where an image is selected, if the processing parameter setting button is pushed, the image processing parameter is renewed (overwritten) by that which was used when the selected image was image-processed.

More specifically, because image processing conditions used in the latest image processing for each image are stored in the memory, when processing parameter setting button 24a is pushed, the image processing conditions stored in memory 14 are read out, and image processing parameter values which are likely to determine the image processing conditions are calculated reversely, based on the image processing conditions. Next, the ID number of the image processing parameters referred to during the image processing of the image is acquired from the memory. Then the image processing parameter values, calculated reversely from the image processing condition, overwrite the stored image processing parameters having the ID number.

In the condition where any one image is selected, when processing parameter initializing button 24b is pushed, the image processing parameters which were referred during the image processing of the selected image, are changed to the initial setting prior to the manufacturer's shipment. Specifically, regarding each image processing parameter set corresponding to each body part, the parameter values of the manufacturer's initial setting and the parameter values referred to during the image processing are both stored in memory 14. At shipment from the manufacturer, the parameter values of manufacturer's initial setting are set as the parameter values to be referred to during image processing. When the processing parameter initializing button 25b is pushed, the ID number which was referred to during the image processing of the image is acquired from memory. The parameter values of manufacturer's initial setting are read out from the memory means and the parameter values of manufacturer's initial setting overwrite the parameter value referred to during the image processing which is stored in memory 14.

Further, in addition to providing a processing parameter undo button, it can be structured that the latest image processing parameter values before it is changed are stored in memory 14 for every image processing parameter corresponding to each body part so that when processing parameter setting button 24a is pushed, image processing parameter values before the change are stored, and when the processing parameter undo button is pushed, image processing parameters referred to during image processing may overwrite the image processing parameter values before the change.

When the desired image is obtained, the OK button provided near each image is selected and if the read image is not the desired one, the NG button is pushed. When the NG button is pushed, the image data are deleted in image display area 23 and also in memory 14. When the OK button is pushed, an OK mark showing that the image has been confirmed is added near the image, and the OK button and the NG button, which have been displayed, are deleted.

Next, after the desired image is obtained in Step S112, setting of the output condition to output the image to a printer such as a laser imager is conducted. In this output condition, are the film size, the film orientation and the output format specifying the position of a plurality of images on a film, and although users can set these output conditions on the output property screen, to be described later, in the case of a medical practitioner's clinic having no specified operators, radiologists or doctors themselves have to set the output conditions every outputting occasion, which can be troublesome. Accordingly, in this embodiment, the structure is such that output condition can be set manually or automatically. The detailed method of which will be explained below.

When output conditions are set manually, they are set with default output format button 25a and the property button previously provided on output area 25 of image confirmation/output screen 21. This default output format button 25a is used to select the output format when data are outputted to a printer such as a laser imager. Every time when default output format button 25a is pushed, the default format to be outputted is arranged to be changed to the next one of some prescribed formats one after another in the order, and therefore, one of formats is always stored in the selected condition and the selected format name is displayed on the button.

Specifically, in this example, as patterns to arrange and output a plurality of images on one sheet of film, there are provided six patterns of “A”, “AA”, “A/A”, “AB”, “A/B”, “AB/CD”, and “A” represents a format for outputting one image, “AA” represents a format for outputting two images so that two images are created by applying two different image processing to one image, which are arranged side by side, “A/A” represents a format for outputting two images so that the two images created by applying two different image processing to one image are arranged up and down to output, “A/B” represents a format outputting two different images arranged up and down to output, “AB/CD” represents a format outputting four images so that four different images are arranged in two vertical rows and in two horizontal rows. Accordingly, each of formats “A”, “AA”, “A/A” needs image data for one image, each of formats “AB”, “A/B” needs image data for two images and format “AB/CD” needs image data for four images.

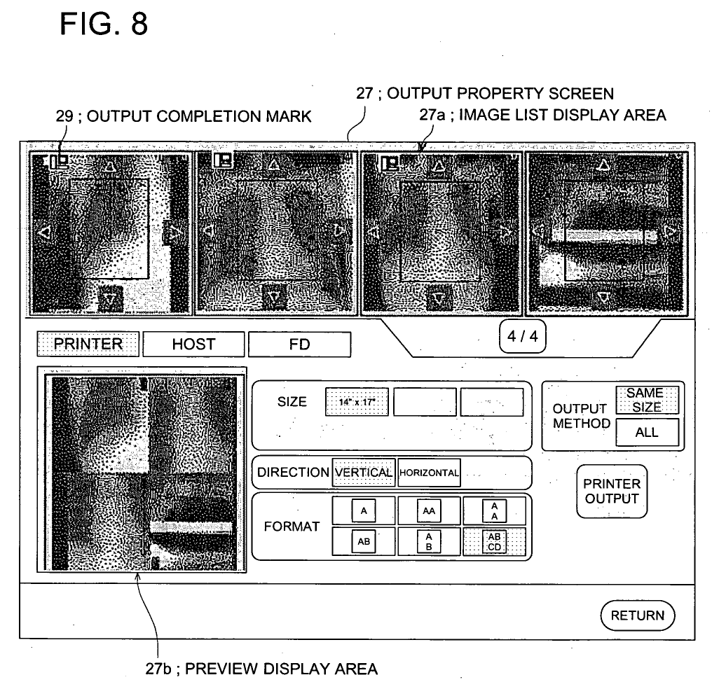

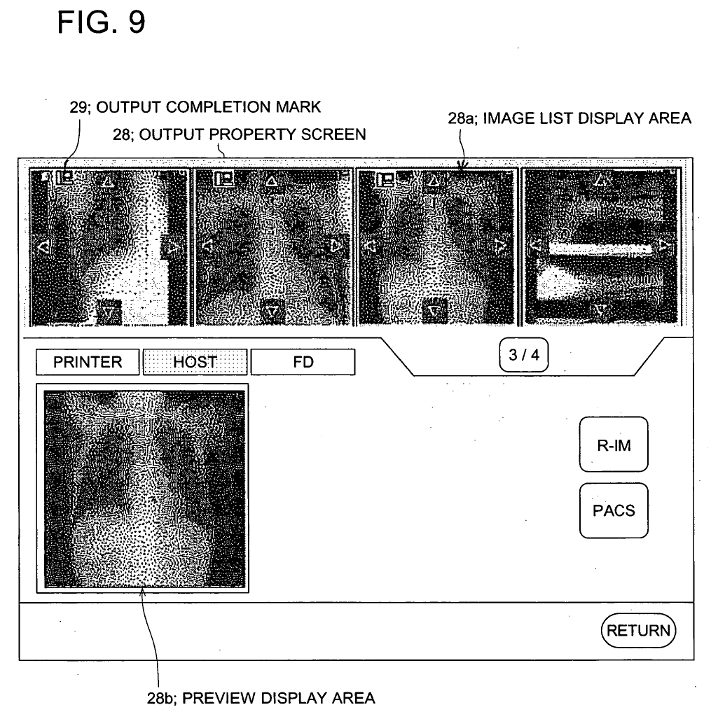

When the size and the orientation of the film are set, the output property screen shown in FIG. 8 or FIG. 9 is allowed to be displayed by pushing the property button in output area 25, and the size and the orientation are set on the output property screen.

FIG. 8 is an example of the structure of the output property screen when a printer is selected as an output destination and FIG. 9 is one when the host is selected as an output destination. When a printer is selected as an output destination, as shown in FIG. 8, an operator selects the film size with the size selection button on output property screen 27 and then instructs which direction, vertical (portrait) or horizontal (landscape), the film is placed with the film direction selection button. Next, the output format is selected with the format selection button. The position of an image of image data in one film is displayed on preview display section 27b. This display is separated by divisions of area size corresponding to image data of one image.

On the upper end of this output property screen 27 is image list display section 27a where image data which has been read are displayed. When one image is selected from this image list display section 27a, and then a division of one image data is selected on preview display section 27b, image data is allocated in the position of the selected division of the format.

It is possible to change the cutout size when image data is arranged to the format with the cutout size selection button. When the “all” button is pushed, each image of image data to be located in the output format is reduced to the area size corresponding to the divisions in the output format to display the entire image. When the “same size” button is selected, the scale is not changed and data of the corresponding area size in the output format is cutout from the image data.

In image list display area 27a, the size and position of cutout of each image is shown by a framed box when the output is made in the selected output format, and the position of the cutout of each image is adjusted by adjusting the position of this framed box by operating the cutout position adjusting buttons. At this time, if an image to adjust the cutout position has been already arranged in a division within the output format displayed on preview display area 27b, the cutout position adjustment is made in conjunction with the cutout position adjustment made in image list display area 27a, the image data cut out at the position is displayed in preview display area 27b.

At this time, when all the image data in the format specified by default output format button 25a cannot be located within one sheet of film of the size that has been set, the size of the area of that film, when that film is divided into areas of equal size, is calculated based on the amount of image data to be outputted using that format, and this size is taken as the image cutout size for each image data. At this time, the image size that is to be cutout in each image is displayed as framed boxes in each image data displayed in image display area 23, when the output is made in this default output format. In the default output format, the image data is cut out so that the distances to the top and bottom edges as well as to the left and right edges from the cutout position are equal. The setting of this cutout position can be changed in the output property screen, to be described later.

In this manner, although it is possible to output the selected images using a specific output format on a film, of a specific size and orientation, by setting the film size, the film orientation, and the output format on output property screen 27, as has been described above, it is desirable, in the case of medical practitioners radiographing limited parts of the body in predetermined patterns, to enable diagnosis using radiographic images with as simple an operation as possible. In view of this, in the present preferred embodiment of the present invention, when the above output conditions are not set manually, the output conditions are set automatically by the image output control section 13 taking as input parameters the image size (cassette size), diagnosing direction of the image, and the number of images (number of frames) to be recorded on one sheet of film. The procedure of automatically setting the output conditions is explained below referring to the drawings of FIGS. 11 to 14, taking the example in which sheets of film of the four sizes 14″×17″, 14″×14″, 11″×14″, and 8″×10″ are loaded in the printer.

[In the Case of 1 Frame]

When only a single frame is to be recorded on a single sheet of film, the processing is done according to the flowchart of FIG. 11. To begin with, in Step S201, the image size, the image diagnosing direction of the film, and the number of frames are set as the input parameters. Although these input parameters can be entered by the operator using display/control section 12, it is further also possible to obtain the image size and the image diagnosing direction of film from reader 2, and it is possible to set the number of images selected in image display area 23 of image confirmation/output screen 21 as the number of frames to be outputted.

Next, image output control section 13 acquires the size (8″×10″) of cassette 17, having images recorded in it from reader 2, and sets the short side (a) to 8″ and the long side (b) to 10″.

Next, in Step S202, image output control section 13 acquires from the printer connected to controller 3 the types of film sheets loaded in the printer, selects the smallest sized film among these in Step S203, and determines the short side (a′) and the long side (b′) in Step S204. In this case, the setting of the smallest size of 8″×10″ is made by setting the short side (a′) to 8″ and the long side (b′) to 10″.

Next, in Step S205, the short side (a) of the image and the short side (a′) of the film, and the long side (b) of the image and the long side (b′) of the film are compared respectively, and the judgment is made whether the relationships of a′≧a and also b′≧b are both satisfied. When these conditions are satisfied, the selected film is set as the film onto which the image output is to be made. However when these conditions are not satisfied, the film with the next smallest size is selected among the films loaded in the printer in Step S206. Next, if the selected film is not the largest sized film loaded in the printer, the processing of Step S204 and Step S205 are again carried out in a similar manner, or else if the selected film is the largest sized film loaded in the printer, the film is set as the one onto which the output is to be made. Then, the size of the set film is determined in Step S208.

Next, in Step S209, the image length in the horizontal direction and the image length in the vertical direction are determined for the image read out by reader 2 based on the selection of whether to diagnose the image in the vertical direction (portrait orientation) or in the horizontal direction (landscape orientation) The lengths in the two directions based on this diagnosing direction of the film are compared with the length in the horizontal direction (8″) and the length in the vertical direction (10″) for the case when the short side of the film (8″×10″) is placed horizontally, and the length in the horizontal direction (10″) and the length in the vertical direction (8″) are compared in the case when the long side of the film (8″×10″) is placed horizontally, and the closest configuration, in other words, the direction with the smaller difference in the aspect ratio is selected for the film orientation.

This sequence of operations is shown schematically in FIG. 13. When cassette 17, inserted in reader 2, is an 8″×10″ cassette, the image output from reader 2 has a short side length of 8″ and a long side length of 10″. When the selected diagnosing direction of the film is the portrait orientation, the 8″×10″ portrait orientation film is selected (the next smallest sized film is selected when no 8″×10″ film has been loaded in the printer) and when the selected diagnosing direction of the film is the landscape orientation, the 8″×10″ landscape orientation film is selected (similar to the above, the next smallest sized film is selected when no 8″×10″ film has been loaded in the printer), and the image is outputted using the selected film. However, at the time of outputting the image onto the film, if the image data read in reader 2 and subjected to image processing is transmitted to the DICOM imager by specifying the file size information and the portrait orientation according to the DICOM standard, the DICOM imager receiving the image data selects the film size and controls the position of writing the image data and the position of writing the patient ID for the selected size. As a result, the patient ID has the normally readable orientation in the selected diagnosing direction.

[In the Case of 2 Frames]

When two frames are to be recorded on a single sheet of film, the processing is done according to the flowchart shown in FIG. 12. To begin with, in Step S301, the image size, the image diagnosing direction of the film, and the number of frames are set as the input parameters. Next, in the case of two frames since it is possible to arrange the two frames horizontally (in a left to right direction) or vertically (in a top to bottom direction), the film size is determined using the following procedure for the respective type of arrangement.

The following explanation is given for the example in which the diagnosing direction has been specified as the portrait orientation. To begin with, when the frames are arranged horizontally, in Step S303, image output control section 13 acquires the size of cassette 17 (8″×10″ size) having the images received from reader 2 and recorded in it, and sets the images of the two frames in the horizontal (left to right) direction and sets the length of the short side (a1) of the overall image to 10″, and the length of the long side (b1) of the overall image to 16″. Further, in Step S304 image output control section 13 acquires from the printer connected to the controller 3 the types of films loaded in that printer, selects the smallest sized film from among these in Step S304, and determines the short side (a′) and the long side (b′) of the selected film in Step S305.

Next, in Step S306, the short side (a1) of the image and the short side (a′) of the film, and the long side (b1) of the image and the long side (b′) of the film are compared respectively, and the judgment is made whether the relationships of a′≧a1 and also b′≧b1 are both satisfied. When these conditions are satisfied, the selected film is set as the film onto which the image output is made, but when these conditions are not satisfied, in Step S307, the film with the next smallest size is selected among the films loaded in the printer. Next, if the selected film is not the largest sized film loaded in the printer, the processing of Steps S305 and S306 are carried out in a similar manner, or else if the selected film is the largest sized film loaded in the printer, the film is set in Step S309 as the one to which the output is to be made.

Next, when the frames are arranged vertically, in Step S303′, image output control section 13 acquires the size of cassette 17 (8″×10″ size) having the images received from reader 2 and recorded in it, and sets the images of the two frames vertically (top to bottom) and sets the length of the short side (a2) of the overall image to 8″ and the length of the long side (b2) of the overall image to 20″. Further, in Step S304′ image output control section 13 acquires from the printer connected to the controller 3 the types of film sheets loaded in the printer, selects the smallest sized film among these in Step S304′, and determines the short side (a′) and the long side (b′) of the selected film in Step S305′.

Next, in Step S306′, the short side (a2) of the image and the short side (a′) of the film, and the long side (b2) of the image and the long side (b′) of the film are compared respectively, and the judgment is made whether the relationships of a′≧a2 and also b′≧b2 are both satisfied. When these conditions are satisfied, the selected film is set as the film onto which the image output is to be made, and when these conditions are not satisfied, in Step S307′, the film with the next smallest size is selected from among the film sheets loaded in the printer. Next, if the selected film is not the largest sized film loaded in the printer, the processing of Steps S305′ and S306′ are carried out in a similar manner, or else if the selected film is the largest sized film loaded in the printer, the film is set as the one to which the output is to be made in Step S309′.

Further, in Step S310, the films set for the horizontal arrangement and for the vertical arrangement are compared, and the film with the smaller size among these two films and the film dividing direction (image arrangement direction) are selected. Further, when the film sizes are the same in these two cases, the film and film dividing direction (image arrangement direction) having a more similar shape (smaller difference of the aspect ratio) are selected. In the above example, for horizontal arrangement the 14″×17″ size is selected because it matches the conditions, and for vertical arrangement since there is no size matching the conditions, the 14″×17″ size is selected as the maximum size. Further, for the film dividing direction, the horizontal arrangement is selected because it has a smaller difference in the aspect ratio with the film of the selected size (14″×17″). Further, during the selection of the film size, since it implies that the entire image cannot be outputted when there is no matching size, and therefore the maximum size is selected, it is desirable either to use automatic magnification ratio conversion that can permit the output of the entire image or to select the output range (area) of the image in the output property screen described earlier (by narrowing the output area) without changing the magnification ratio.

Subsequently, in Step S311, based on the diagnosing direction of each frame of the image, the length in the horizontal direction (8″) and the length in the vertical direction (10″) are compared with the length in the horizontal direction (7″) and the length in the vertical direction (17″) of the area obtained by halving the selected 14″×17″ size film in the left to right direction when it is placed so that its short side is horizontal, and compared with the length in the horizontal direction (8.5″) and the length in the vertical direction (14″) of the area obtained by halving the selected 14″×17″ size film in the left to right direction when it is placed so that its long side is horizontal, and the nearest shape, in other words, the direction with the smaller difference in the aspect ratio is selected as the film orientation. In this case, the film orientation of making its long side horizontal is selected.

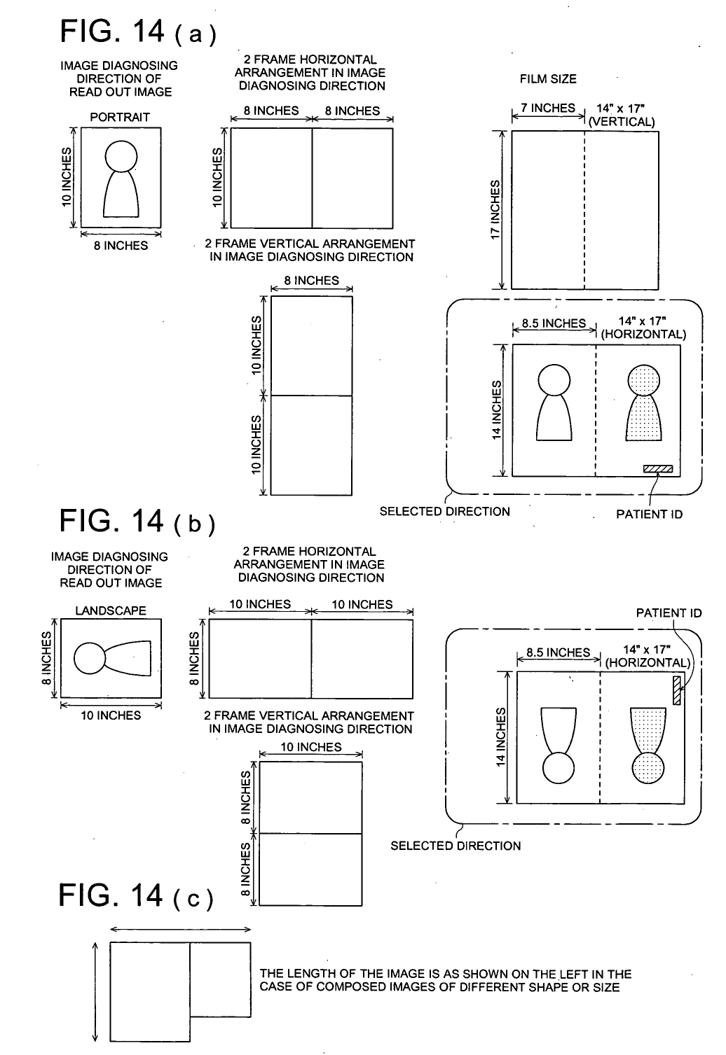

This sequence of operations is shown schematically in FIG. 14. Further, at the time of outputting the image onto the film, if the image data read in reader 2 and subjected to image processing is transmitted to a DICOM imager specifying the file size information and the portrait orientation according to the DICOM standard, the DICOM imager receiving that image data selects the film size and controls the position of writing the image data and the position of writing the patient ID for the selected size. As a result, the patient ID is in the normally readable orientation in the selected diagnosing direction.

[In the Case of 4 Frames]

In addition, in the case of recording four frames in a single sheet of film, the processing is made according to the flow chart shown in FIG. 11, being similar to the case of recording a single image on a single sheet of film. To begin with, in Step S201, the image size, the image diagnosing direction, and the number of frames per sheet of film are set as the input parameters.

Next, in Step S202, image output control section 13 acquires the size of cassette 17 having images that have been received from reader 2 and recorded in cassette 17, and determines the short side (a) and the long side (b) of the overall image obtained by arranging four frames of images of the size of cassette 17 in a portrait orientation in a 2-row×2-column array.

Next, image output control section 13 acquires from the printer connected to controller 3 the types of film sheets loaded in that printer, selects in Step S203 the smallest sized film among these, and determines in Step S204 the short side (a′) and the long side (b′).

Next, in Step S205, the short side of the image (a) and the short side of the film (a′), and the long side of the image (b) and the long side of the film (b′) are compared respectively, and the judgment is made whether the relationships of a′≧a and also b′≧b are both satisfied. When these conditions are satisfied, the selected film is set as the film onto which the image output is to be made, and when these conditions are not satisfied, in Step S206, a sheet of film with the next smallest size is selected from among the film sheets loaded in the printer. Further, if the selected film is not the largest sized film sheet loaded in the printer, the processing of Steps S204 and S205 are carried out again in a similar manner, or else if the selected film sheet is the largest sized film loaded in the printer, the film is set in Step S208 as the one onto which the output is to be made.

Subsequently, in Step S209, in addition to evaluating the closeness of the shape (difference in aspect ratios) between 1/4 sized film of the vertical orientation and the image of the portrait orientation to be recorded in this area, the closeness of the shape (difference in aspect ratios) between 1/4 size film of the horizontal orientation and the image of the portrait orientation to be recorded in this area is evaluated, and the closeness of the shape obtained for vertical and horizontal orientations are compared for identical frames, and then in Step S210, the orientation in which there is a larger number of frames having the more closer shapes (smaller differences in aspect ratios) is selected. Further, when the number of frames having closer shapes is the same between the two orientations, the sum of the differences in aspect ratios of each frame in the vertical orientation of the film is compared with the sum of the differences in the aspect ratios of each frame in the horizontal orientation of the film, and the orientation with the smaller of the two sums is selected. In this case, since there is no size matching the conditions, the size of 14″×17″ is selected as the maximum size. Further, during the selection of the film size, since it implies that the entire image cannot be outputted when there is no matching size, and therefore the maximum size is selected, it is desirable either to use automatic magnification ratio conversion that can permit the output of the entire image, or to select the output range (area) of the image in the output property screen described earlier (under narrowing the output area) without changing the magnification ratio.

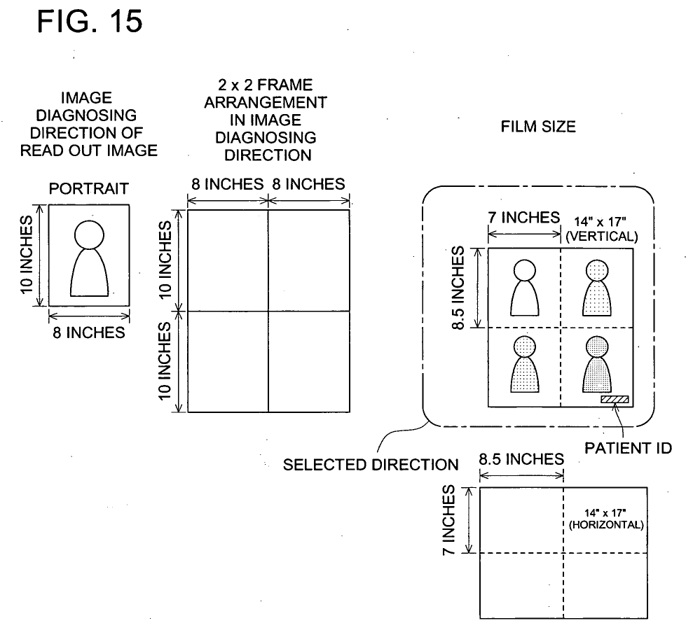

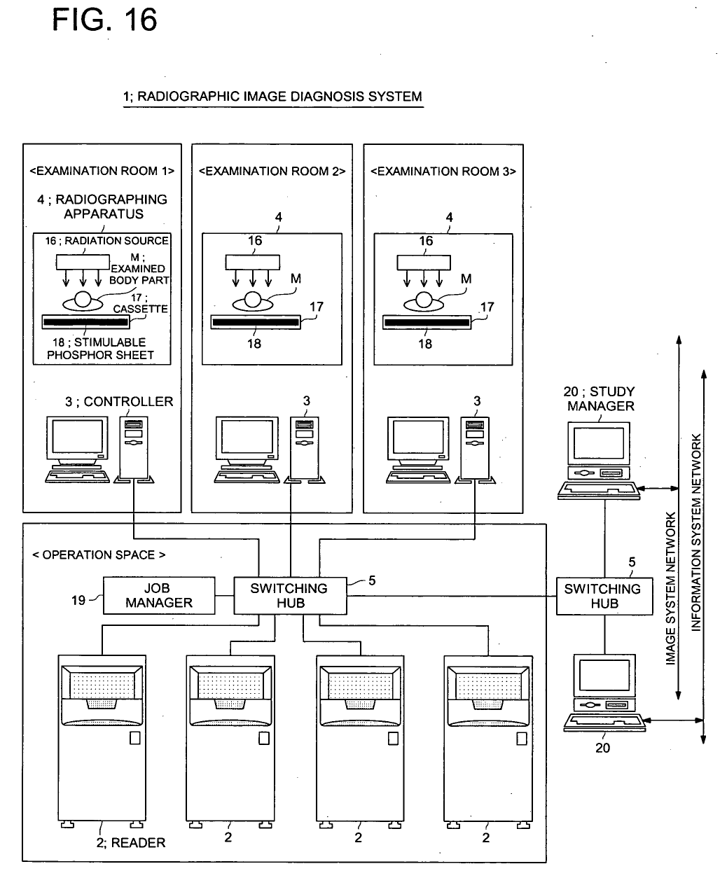

This sequence of operations is shown schematically in FIG. 15. When cassette 17, inserted in reader 2, is an 8″×10″ cassette, the image with four frames arranged (in 2 rows×2 columns) has a short side length of 16″ and a long side length of 20″, and the 14″×17″ film is selected (but if 14″×17″ film is not loaded in the printer, the next smallest film is selected), and the area of one frame of the image will be 7″ (short side)×8.5″ (long side) when the orientation of the film is vertical, and will be 8.5″ (short side)×7″ (long side) when the orientation of the film is horizontal, and hence the image is outputted selecting the horizontal orientation because it is closer to the aspect ratio of one image frame.

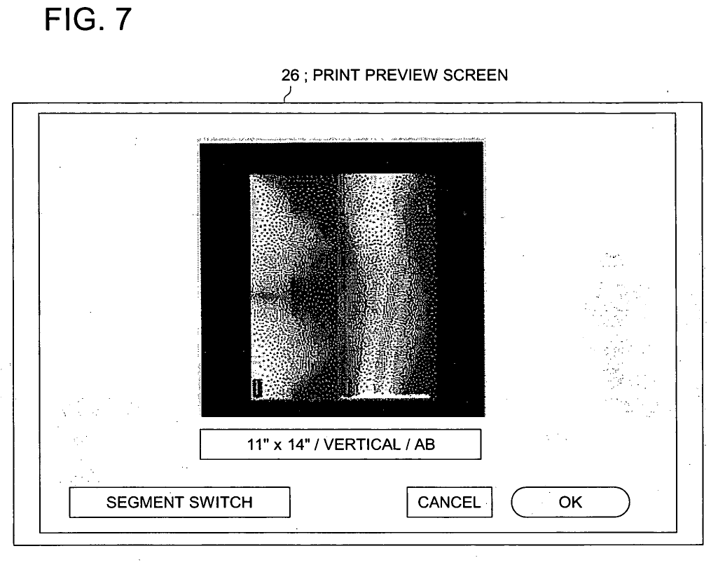

Further, when the output conditions are set automatically by image output control section 13, when the OK button, provided near the periphery of each image in the image display area 23, is selected, the data of the image for which the OK button was pressed is entered in the default output format queue. At this time, if the number of image data items held in the default output format queue is equal to the number of image data items required by the format specified in the default output format button, print preview screen 26 is displayed showing the film outputs image in the format, as shown in FIG. 7.

When the OK button is pressed in print preview screen 26, the image data corresponding to the output image displayed in Step S113 in FIG. 10 is outputted to a printer, such as a laser imager, and print preview screen 26 shown in FIG. 7 is closed. The image data outputted at this time to a printer, etc. is removed from the default output format queue. If the cancel button is pressed on print preview screen 26, the output is not made to the printer and only print preview image 26 is closed. At this time, the image data for which the OK button was pressed last in image display area 23 of image confirmation/output screen 21, are removed from the default output format queue.

Next, when the “end” button is pressed, the display returns to the initial screen, but at this time the images that have not yet been outputted are arranged successively, and outputted according to the format specified in the default output format in image confirmation/output screen 21.

In this manner, according to the image output controlling method and the image output controlling program of this preferred embodiment of the present invention, since the size of the film to be outputted, the film orientation, and the direction of dividing the film sheet are all set automatically using the image size (the size of cassette 17), the image diagnosing direction, and the number of frames in the image as the input parameters, it is not necessary to set the output conditions every time a medical image is to be outputted and hence it is possible to greatly enhance the ease of operation.

1. An image output controlling method to output a radiographic image obtained by radiographing a subject on a film, comprising steps of:
acquiring a size of the radiographic image, a diagnosing direction of the radiographic image and a number of frames of the radiographic images to be recorded on one sheet of the film, as input parameters,
setting automatically a size of the film on which one or a plurality of the frames of the radiographic images are to be recorded, an orientation of the size of the film and a direction of dividing the size of the film when recording a plurality of frames of the radiographic images on the film based on the input parameters, according to a predetermined procedure.

2. The image output controlling method described in claim 1, comprising in a step of setting the size of the film:
a first step of obtaining a short side (a) and a long side (b) of a size of a single frame of the radiographic image or of an overall size of an arrangement of a plurality of frames of the radiographic images,
a second step of selecting a smallest sized film loaded in a printer,
a third step of obtaining a short side (a′) and a long side (b′) of the selected film,
a fourth step of comparing the short side (a) with short side (a′) and the long side (b) with the long side (b′) and of checking whether or not relations of a′≧a and also b′≧b are both satisfied, and
a fifth step of designating the selected film as a film for recording the single frame or the plurality of frames of radiographic images when the relations are satisfied, or else, if the relations are not satisfied, of selecting a next smallest sized film and of repeating the steps from the third step onward.

3. The image output controlling method described in claim 2,
wherein when there are two frames of radiographic images to be recorded, designation of the film is carried out, for both the two frames of the radiographic images, for both arrangements of the frames in a left to right direction and in a top to bottom direction while maintaining a diagnosing direction of the respective frames, and when sizes of the two designated films are different, not only a smaller film of the two films is designated as a film where the two radiographic images are to be recorded but also a direction of dividing the film is set according to the direction of the arrangements of the frames of the radiographic images, and when there are four radiographic images to be recorded, a film is designated for outputting all the four radiographic images by arranging them in two rows and two columns while maintaining a diagnosing direction of each of four frames of the radiographic images.

4. The image output controlling method described in claim 1,
wherein in a step of setting the orientation of the film, an aspect ratio of an area for recording one frame of the radiographic image on the designated film is compared with an aspect ratio of the radiographic image in a diagnosing direction of the film, and the orientation of the film is set using a difference between the aspect ratios.

5. The image output controlling method described in claim 4,
wherein when only one frame of the radiographic image is present, the orientation of the film is set by comparing an aspect ratio of the designated film with an aspect ratio of the frame of the radiographic image in the diagnosing direction, when two frames of the radiographic images are present, the orientation of the film is set by comparing an aspect ratio of 1/2 of an area of the film with an aspect ratio of one frame of the radiographic image to be recorded in the 1/2 of the area in the diagnosing direction when the designated film is placed vertically, and also comparing an aspect ratio of 1/2 of an area of the film with an aspect ratio of one frame of the radiographic image to be recorded in the 1/2 of the area in the diagnosing direction when the designated film is placed horizontally, and designating an orientation for which a sum of differences of the aspect ratio is smaller as the orientation of the film, and when four frames of the radiographic images are present, the orientation of the film is set by comparing an aspect ratio of 1/4 of an area of the film with an aspect ratio of one frame of the radiographic image to be recorded in the 1/4 of the area in the diagnosing direction when the designated film is placed vertically, and also comparing an aspect ratio of 1/4 of an area of the film with an aspect ratio of one frame of the radiographic image to be recorded in the 1/4 of the area in the diagnosing direction when the designated film is placed horizontally, and designating an orientation for which a sum of differences of the aspect ratio is smaller as the orientation of the film.

6. An image output controlling program to output a radiographic image obtained by radiographing a subject on a film, allowing a computer to function as an image output controlling means, comprising:
an acquiring section to acquire a size of the radiographic image, a diagnosing direction of the radiographic image and a number of frames of the radiographic images to be recorded on one sheet of the film, as input parameters and
a setting section to automatically set a size of the film on which one or a plurality of the frames of the radiographic images are to be recorded, an orientation of the size of the film, and a direction of dividing the size of the film when recording a plurality of frames of the radiographic images on the film based on the input parameters, according to a predetermined procedure.

7. The image output controlling program described in claim 6, comprising in a processing of setting the size of the film:
a first processing of obtaining a short side (a) and a long side (b) of a size of a single frame of the radiographic image or of an overall size of an arrangement of a plurality of frames of the radiographic images,
a second processing of selecting a smallest sized film loaded in a printer,
a third processing of obtaining a short side (a′) and a long side (b′) of the selected film,
a fourth processing of comparing the short side (a) with short side (a′) and the long side (b) with the long side (b′) and of checking whether or not relations of a′≧a and also b′≧b are both satisfied, and
a fifth processing of designating the selected film as a film for recording the single frame or the plurality of frames of radiographic images when the relations are satisfied, or else, if the relations are not satisfied, of selecting a next smallest sized film and of repeating the processing from the third processing onward.

8. The image output controlling program described in claim 7,
wherein the image output controlling program controls the image output controlling means so that, when there are two frames of radiographic images to be recorded, designation of the film is carried out, for both the two frames of the radiographic images, for both arrangements of the frames in a left to right direction and in a top to bottom direction while maintaining a diagnosing direction of the respective frames, and when sizes of the two designated films are different, not only a smaller film of the two films is designated as a film where the two radiographic images are to be recorded but also a direction of dividing the film is set according to the direction of the arrangements of the frames of the radiographic images and when there are four radiographic images to be recorded, a film is designated for outputting all the four radiographic images by arranging them in two rows and two columns while maintaining a diagnosing direction of each of four frames of the radiographic images.

9. The image output controlling program described in claim 6,
wherein the image output controlling program controls the image output controlling means so that, in a processing of setting the orientation of the film, an aspect ratio of an area for recording one frame of the radiographic image on the designated film is compared with an aspect ratio of the radiographic image in a diagnosing direction of the film, and the orientation of the film is set using a difference between the aspect ratios.

10. The image output controlling program described in claim 9,
wherein the image output controlling program controls the image output controlling means so that, when only one frame of the radiographic image is present, the orientation of the film is set by comparing an aspect ratio of the designated film with an aspect ratio of the frame of the radiographic image in the diagnosing direction, when two frames of the radiographic images are present, the orientation of the film is set by comparing an aspect ratio of 1/2 of an area of the film with an aspect ratio of one frame of the radiographic image to be recorded in the 1/2 of the area in the diagnosing direction when the designated film is placed vertically, and also comparing an aspect ratio of 1/2 of an area of the film with an aspect ratio of one frame of the radiographic image to be recorded in the 1/2 of the area in the diagnosing direction when the designated film is placed horizontally, and designating an orientation for which a sum of differences of the aspect ratio is smaller as the orientation of the film, and when four frames of the radiographic images are present, the orientation of the film is set by comparing an aspect ratio of 1/4 of an area of the film with an aspect ratio of one frame of the radiographic image to be recorded in the 1/4 of the area in the diagnosing direction when the designated film is placed vertically, and also comparing an aspect ration of 1/4 of an area of the film with an aspect ratio of one frame of the radiographic image to be recorded in the 1/4 of the area in the diagnosing direction when the designated film is placed horizontally, and designating an orientation for which a sum of differences of the aspect ratio is smaller as the orientation of the film.
